(19) United States
(12) Patent Application Publication
(10) Pub. No.: US 2011/0198135 A1
(43) Pub. Date: Aug. 18, 2011

(54) WIND TURBINE MOUNTED ON CAR

(76) Inventors: Liudmila Borisovna Kalinina, Moscow (RU); Yury Valentinovich Kriulin, Irkutsk (RU); Vsevolod Dmitrievich Kalinin, Moscow (RU)

(21) Appl. No.: 12/988,805

(22) PCT Filed: Apr. 25, 2008
(86) PCT No.: PCT/IB2008/001040

§ 371 Date: Jan. 8, 2011

(51) Int. Cl. B60L 8/00

(52) U.S. Cl. 180/2.2; 180/65.21; 903/902

(57) ABSTRACT

The invention relaxes to a transport technical field and more precisely to power plants of cars and trucks arid may be used as a power plant of buses, motorcycles, electro-mobiles, in rolling stocks (electromotive, locomotive, carriage, van, etc.), metro, tram, trolleybus, in water-borne transportation and in air transport as well as for 2 creation of local power stations. The declared invention is characterized in that a combined aerodynamic power-plant (CAPP) in a vehicle motion generates by means of incoming air flow an electric energy and distributes it between the vehicle wheels. A quantity of the energy generated in air units of the power plant CAPP makes up not less than 50% of energy necessary and sufficient for uniform rectilinear motion of the vehicle. The construction of the power plant CAPP is smoothly combined with modern standard vehicles and with their power plants both in the electro-mobiles and the vehicles with hybrid power plants essentially improving their technical and ecological characteristics.

### TECHNICAL FIELD

The invention relates to a transport technical field and more precisely to power plants of cars and trucks and may be used as a power plant of buses, motorcycles, electro-mobiles, in rolling stocks (electromotive, locomotive, carriage, van, etc.), metro, tram, trolleybus, in water-borne transportation and in air transport as well as for a creation of local power stations.

### PRIOR OF ART

Accordingly the data of World Health Organization (WHO), an automobile is one of main sources of environment pollution. It consumes more than 90% of all the produced oil-products. There is an attempt to decrease the consumption of hydrocarbon oil grades in automotive transport by means of various ways. One of them consists in that upon an automobile motion power plant produces an electric energy by means of kinetic energy of incoming air flow. The electric energy, obtained by such a way, is used for an additional charge of rechargers (an accumulator, accumulator battery and so on) and/or for an automobile motion.

There is known an automobile power plant construction, allowing to generate an electric power by means of head air flow, and this construction is represented in the U.S. Pat. No. 7,147,069 B2, dated on the Dec. 12, 2006.

An aerodynamic portion of the given power plant, destined for a conversion of kinetic energy of incoming air into an electric generator shaft, consumed for an electric energy generation, is arranged in the front portion of automobile and along its sides. It is carried out in the form of air units, inside of which there are placed wind wheels, an axis of rotation of which is oriented both the transversely and vertically with respect to the longitudinal axis of automobile, i.e. perpendicularly to its motion. Each wind wheel is accomplished in the form of rotor with blades, but already these blades are not flat ones, but they are convex and concave ones. Upon the automobile motion the incoming air flow presses onto the surfaces of blades and rotates them, generating an electric power by means of known way. A shape of the blades is selected in such a way that upon a movement of the blade by the help of incoming air flow for the generation of the electric power its drag is maximally possible (a concave side), but upon a movement of the blade invertedly its drag is minimal one, i.e., it is less than a flat plate drag (a convex side).

By means of improvement of aerodynamic characteristics of the given construction and by means of application of the wind wheel blades with higher lift properties a value of the electric power, generated by means of incoming air flow, may be increased approximately one and half or twofold without of enlargement of the aerodynamic portion dimensions, and it is confirmed by means of experimental and research engineering. Thus, upon the automobile motion with speed of 50 to 70 km/h (a coefficient of resistance to rolling friction k equals to 0.05), the value of the generated electric power will make up already of about of 2 to 2.5 κW per 1 M² of square of inlet section of air units.

The known power plant is capable to generate 8 to 10% of power (N_{el.}), that is necessary for a uniform rectilinear traffic of automobile with weight of 1 tone (N_{req}.), i.e.,

N_{el.}=0.1N_{reg.}

A further enlargement of the electric energy, generated by means of the incoming air flow, without of enlargement of dimensions of the inlet section of the air units will allow to increase coefficient of efficiency the power plant, an effectiveness of exploitation of vehicles aerodynamic and to provide with a decrease of consumption of hydrocarbon and other grades of fuel.

But a refinement and an improvement of the lift properties of the blades of the wind wheel, carried out in accordance with the given scheme, i.e., upon the orientation of the axis of its rotation perpendicularly to the vehicle motion, can not exclude a motion of the wind wheel blades invertedly with respect to the incoming air flow, but it, in turn, does not allow essentially to increase the generation of the electric power.

It is reasonable to exclude inefficient movements of the wind wheel blades invertedly with respect to the motion of the air flow. It may be done by means of variation of the axis of the wind wheel rotation. The given technical solution is known from the U.S. Pat. No. 3,374,849, dated on the Mar. 26, 1968, which is taken as a prototype.

An aerodynamic portion of the given power plant, destined for a conversion of kinetic energy of the incoming air into an electric generator shaft, consumed for an electric energy generation, is arranged inside of vehicle. It is carried out in the form of air unit, inside of which there are placed four wind wheels, an axis of rotation of which is oriented along the longitudinal axis of automobile, i.e. parallel to its motion. Each wind wheel is accomplished in the form aerodynamic blades fastened rigidly on a shaft, that is connected to the electric generator shaft. Upon the automobile motion the incoming air flow passing with respect to the blades of the wind wheel, creates on their surfaces aerodynamic forces directed to the side of rotation, generating an electric power by means of known way. The given construction allows to exclude inefficient movements of the blades of the wind wheel.

Upon small speeds of the vehicle motion (till 15 to 20 κm/h) and upon a rotation of first wind wheel stream-wise there is present an insignificant downwash of flow behind it, which weakly influences on a character of flow-around of wind wheels, following after it. Distances between the wind wheels are comparable ones or rather more than their radiuses, and it contributes to a gradual leveling of air flow upon its movement along an aerodynamic unit air-gas channel of sufficiently long length. Upon an increase of the vehicle motion speed (more than 20 κm/h), the air flow behind the first wind wheel acquires a steady angle of downwash (see page 332 [symbol] [symbol] [symbol] [symbol] [symbol] [symbol] [symbol] [symbol] 1970Γ. [1]), and in this connection the flow-around of second wind wheel and following wheels occurs with a down wash, and it significantly decreases lifting properties of the blades and does not contribute to a creation of aerodynamic forces on them, directed onto the side of rotation of the wind wheels. Since all the wind wheels are rigidly fastened on one shaft, even a respectively satisfactory effectiveness of the first wind wheel operation, being in more favorable mode of flow-around, is significantly decreased due to a decrease of lifting properties of the aerodynamic blades of the second wind wheel and the following wind wheel behind it, but great distances between the wind wheels enlarge a value of hydraulic losses of the power plant air unit. All these drawbacks bring to naught the main advantage of the power plant with the longitudinally oriented wind wheels and in a consequence of it the conversion of the incoming air flow kinetic energy into the electric energy is on a very low level.

In order to increase the generation of the electric energy it is necessary to introduce changes in the given construction of the power plant, which would allow significantly to decrease the air-gas channel of its aerodynamic construction and correspondingly a value of hydraulic losses. It is also necessary to eliminate an influence of air flow downwash providing with an optimal yaw of air to the aerodynamic blades of all the wind wheels in order to increase their lifting forces. The given constructive changes will allow to enlarge coefficient of the power plant efficiency and to increase the effectiveness of the exploitation of vehicles.

### DISCLOSURE OF INVENTION

A problem of the present invention consists in a power plant development, which differs from the known analogous technical solutions in that the generation of the electric energy in it by means of the kinetic energy of the incoming air flow takes place with significantly higher coefficient of efficiency, and it allows:
to decrease a consumption of hydrocarbon and other grades of fuel and energy not less than twofold;
to constrict emissions of exhaust gases and hazardous agents;
to decrease a thermal influence on atmosphere.

In order to solve these problems there are made modifications in an aerodynamic construction of offered power plant, allowing to decrease hydraulic losses and to provide with optimal conditions of incoming air flow-around of aerodynamic blades of the wind wheels, longitudinally oriented. The offered constructive modifications allow to increase several times a value of generated electric energy without of enlargement of square of inlet section of aerodynamic portion of the power plant.

To this end in the air-gas channel of the designed power plant the distance between the wind wheels is significantly decreased and is determined by means of minimal gaps between constructive elements in the axial and radial directions. In order to eliminate the downwash of air flow in close vicinity before and after the wind wheel there is mounted guiding (straightening) aerodynamic vanes.

Thus, in the declared vehicle power plant comprising an engine connected to the vehicle propelling device and an aerodynamic construction including at least one wing wheel with blades, carried out with a possibility of energy obtaining from an incoming air flow and generating an electrical energy by means of electric generator connected to it in order to transfer the electrical energy to the vehicle propelling device, in the vicinity of the wind wheel there are mounted guiding vanes, providing an optimal angle of flow-around of that wind wheel by the incoming air flow, and straightening vanes after its blades, therewith the straightening vanes of one wind wheel are guiding vanes of other wind wheel, following after it.

It provides with the optimal angle of the incoming air flow approaching to the wind wheel blades in order to obtain maximally possible aerodynamic lifting forces with the aim of a generated electric energy increasing upon the incoming air flow acting on the wind wheel blades.

In such a vehicle power plant it is preferred to carry out the straightening vanes with a possibility of rotation with respect to their longitudinal axes.

Such an accomplishment of the guiding vanes provides with a possibility of additional change of the angle of the incoming air flow approaching to the rotating wind wheel in order to obtain maximally possible values of the aerodynamic lifting forces with the aim of a generated electric energy increasing by means of air flow incoming onto the wind wheel.

The incoming air flow hits in an air unit of the declared power plant and in immovably mounted guiding vanes it obtains a necessary angle for an optimal approach to the wind wheel aerodynamic blades. Upon the flow-around of the blades of the wind wheel on them there is formed a pressure difference, i.e., the known according to the law of aerodynamics lifting force, directed to the side of rotation of the wind wheel, providing its rotate movement (see page 127. [symbol] [symbol] [symbol] [symbol] [symbol] 1964Γ. [2]). As it was early mentioned in a construction, comprising more than one wind wheel, the immovably mounted guiding vanes of second wind wheel at the same time act as straightening vanes of the first wind wheel, wherein the air flow acquires a necessary direction and at optimal angle approaches the second wind wheel aerodynamic blades creating on them aerodynamic lift forces directed also in the side of the wind wheel rotation and so on. One or several wind wheels of the air unit of the declared power plant (combined aerodynamic power plant—CAPP) air unit are rigidly fastened on one shaft with an electric generator which upon its rotation generates electric energy by means of known way. The generated energy is distributed between electric motors of front and/ or rear wheels putting in a vehicle motion.

Therewith in such a vehicle power unit the guiding vanes and the wind wheel blades in their cross-section may have a convex and concave gas-dynamic cambered aerofoil.

It provides with a possibility of obtainment of the wind wheel maximal possible lifting capability in order to converse by means of it a kinetic energy into a torque on the electric generator shaft.

In such a vehicle power unit it is preferred to carry out with an aerodynamic and geometric twist.

Such an aerodynamic and geometric twist allows to organize along all the span of the wind wheel blade maximally possible aerodynamic lifting forces in order to obtain the maximal torque on the electric generator shaft.

Therewith in such vehicle power plant the incoming air flow may enter into the aerodynamic construction via an air intake of controlled cross-section.

It allows to organize optimal modes of the wind wheel operation for maximally possible generation of electric energy during various speeds of the vehicle motion.

The controlled cross-section of the aerodynamic construction of such a vehicle power unit may decrease its size till zero.

Such a controlled cross-section of the aerodynamic construction allows to provide a possibility of optimal operation of the power unit at insignificant speeds of motion (in the range of 0 to 20 km/h) or at the speeds over 100 km/h when the generation of electric energy by the power unit is not economically profitable.

Besides, such a controlled cross-section of the aerodynamic construction of the declared vehicle power unit may decrease its parasitic drag till zero.

The capability to decrease till zero the parasitic drag of the controlled-section of air intake allows to provide maximally possible speeds of the vehicle power unit motion when the generation of electric energy by the power unit is not economically profitable.

As it was above-mentioned, in such a vehicle power plant it is preferred to arrange the wind wheels in order of the close vicinity with respect to one another with possible minimal gap between own constructive elements in the axial and radial directions.

It decreases an air-gas channel and hydraulic losses during the incoming air flow motion during the vehicle motion.

It is preferred the electric generator in such a vehicle power unit to connect to at least one electrical accumulating battery connected to the vehicle propelling device drive.

It provides with a stable and effective operation of the power unit regardless of the vehicle motion speed due to the fact that the generated electric energy excess is accumulated in a battery and if necessary it is taken-off to a propelling device drive.

In case of automobile motion downwards, when an energy consumption is violently decreased, kinetic energy of the incoming air flow, conversed into an electric energy in air unit, is stored in an accumulator battery similar to the recuperative braking of automobiles with hydride power plants (Toyota Prius, Ford Escape, Lexus RX 400h and so on), increasing its capacity. Upon a motion upwards consumption of energy increases and the electric energy, accumulated in the battery, is supplied to the drive of wheels and it allows to provide with the essential saving of energy as a whole.

In a case of the absence of the requirement of conversion of the incoming air flow kinetic energy into the electric energy and/or in a case of necessity of vehicle aerodynamic drag decreasing the air flow entrance in the air unit is decreased or completely shut by means of decrease of inlet section size in the aerodynamic portion of the power plant CAPP through its complete closing.

### BRIEF DESCRIPTION OF DRAWINGS

The present invention is described to some detail as an example and is accompanied by means of respective drawings, wherein:

FIG. 1 is a side view of the automobile with the power plant CAPP;

FIG. 2 is a plane view of automobile with the power plant CAPP;

FIG. 3 is a front view automobile with the power plant CAPP;

FIG. 4 represents a principal scheme and main constructive elements of the power plant CAPP;

FIG. 5 is a side view of air unit of the power plant CAPP;

FIG. 6 is a principal scheme of the construction of the wind wheel of the air unit;

FIG. 7 a principal scheme of aerodynamic blade of the wing wheel;

FIG. 8 is a top view of the automobile with a partial section of the air unit;

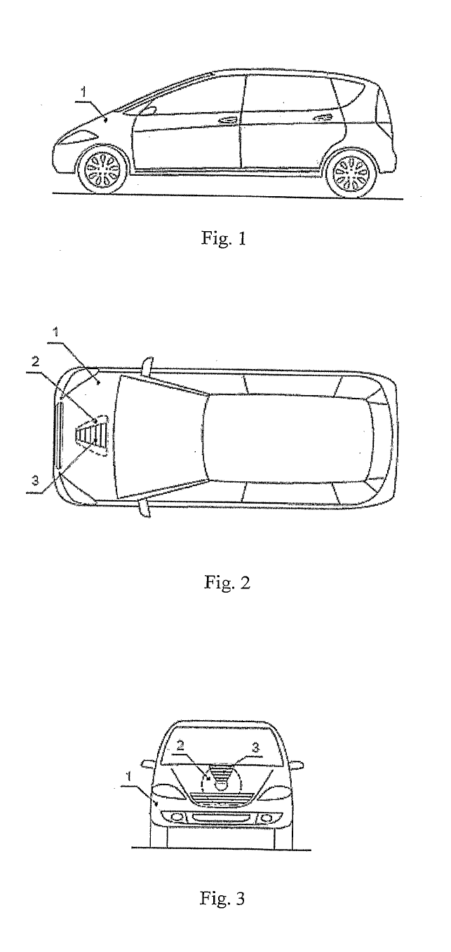

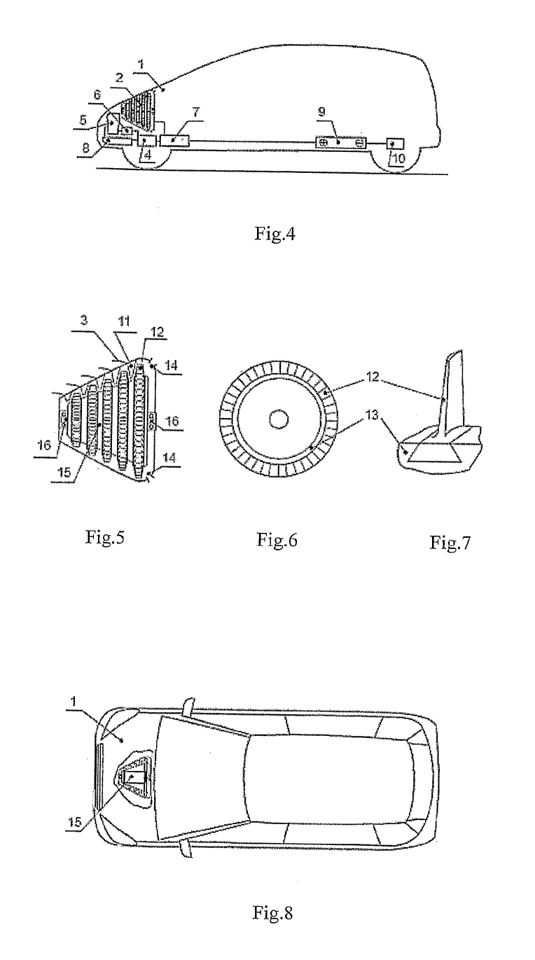

### THE BEST EMBODIMENT OF THE INVENTION

The power plant CAPP for a vehicle 1 comprises an aerodynamic portion, carried out in the form of air unit 2, which is fastened in a hood space in the front part of vehicle 1. During the motion the incoming air flow enters to the air unit 2 via controlled louvers 3. In the front portion of the vehicle there are placed an electric motor of front wheels 4 and a combustion engine 5, which via a hybrid transmission 6 is connected to a generator 7 and to the air unit 2, a coordinated operation of which is controlled by means of the power plant CAPP control unit 8. In the central lower portion of vehicle 1 there is mounted a high voltage battery 9, which is connected to an electrical motor 10 of the rear wheels. Open louvers 3 provide with an access of the incoming air flow to immovably mounted guide vanes and to aerodynamic blades 12 of wind wheel 13 of the air unit 2. Outside of the air unit 2 the air flow is discharged via faucets 14 or is discharged by means of ejection effect in an area of suction or on the combustion engine 5 entrance in order to create air-fuel mixture. A number of the wind wheels 13 of the air init 2 and their size are determined by means of optimal ratio of general dimensions of the power plant construction and technical characteristics of vehicle. In the declared construction of the vehicle 1 there is represented the power plant, the air unit 2 of which comprises five wind wheels, and it allows to arrange an electric generator 15 inside of the air unit 2 between the first and fifth wind wheels 13 on the shaft 16. A construction of each wind wheel 13 of the air unit 2 is identically carried out with respect to one another and differs only by geometrical parameters.

The vehicle power plant CAPP operates as follows.

Upon completely discharged battery 9 the beginning of car 1 motion is realized by means of the combustion engine 5 by means of the known way (the combustion engine may be gas-powered, diesel, gas engine and it may be operated by means of bio-fuel).

With increase of speed (from 35 to 40 κm/h) the incoming air flow passes via open louvers 3 along the guiding vanes 11, wherein it obtains a determined angle of inclination and at this angle it passes along the aerodynamic blades 12 of the wind wheel 13. Under the action of formed aerodynamic lifting forces on the aerodynamic blades 12, directed to the side of rotation of the wind wheel 13, a kinetic energy of the incoming air flow is conversed into a mechanical energy of rotation on the shaft of the wind wheel 13, connected to the shaft 16 of the electric generator. In the same manner, the air flow, passing via the guiding vanes of other wind wheels, rigidly fastened on one axis 16, drives them. In this connection the kinetic energy of the incoming air flow, passing via each wind wheel of the air unit 2, is conversed into the mechanical energy of rotation on the shaft 16 and provides with an obtainment of electrical energy by means of the known way.

With motion of the vehicle 1 in a mode of uniform rectilinear movement the engine 5 energy via the hybrid transmission 6 is distributed between the wheels and the generator 7, which in turn drives electrical engines of the front wheels 4 and the rear wheels 10. If necessary the generator 7 fulfills a recharge of the battery 9, giving off it an excess of energy on the one hand, but on the other hand the air unit 2, operating by means of kinetic energy of the incoming air flow, from the electric generator 15 provides with an entering of electric energy in the battery 9 and further to the electric motors 4 and 10.

A distribution of energy with the view of maximal effectiveness is carried out via the control unit 8 of the power plant CAPP analogously with respect to a control unit of hybrid power plant of the car Lexus RX 400h.

The power plant CAPP, providing a high effective conversion of kinetic energy of the incoming air flow into an electric energy in order to create a motion of vehicle, allows to constrict essentially a necessity in the energy generation by means of various power aggregates, but namely:
by combustion engines (they may gas-powered, diesel, gas and they can be operated by means of bio-fuel and so on),
by electric motors of direct current, of alternate current, by hybrid electric motors and so on,
by electric motors carried out on the basis of fuel elements, electric chemical generators and so on,
by hydrogen engines in various combinations,
by engines, using an atomic energy and so on.

The given restriction of energy generation by means of various power aggregates is possible by means of high effective generation of electric energy from a renewable source of energy in the form of the incoming air flow, and it significantly increases the effectiveness of the power plant CAPP with respect to the known power plants and decreases the necessity of vehicles in any grade of fuel.

A computational and experimental part gives a more complete representation about an energetic balance and effectiveness of the power plant CAPP with respect to currently the known analogous power plants and systems.

Subsequent to the results of natural tests of axial blade machines of turbine type with analogous longitudinally oriented wind blade wheels (see 494, [2]) and technical data, obtained in experimental laboratory installations during a development of the power plant CAPP, a value of generated electrical energy upon speeds of air flow of 50 to 70 κm/h (of 14 to 20 m/s), has a significance of 14 to 16 kW per 1M² of the wind wheel area.

In order to evaluate the energy balance as an example let us consider an uniform, rectilinear motion of a car with the weight of 1 tone and speed of 58 km/h upon the coefficient of resistance to rolling friction k which equals to 0.05. In accordance with main laws of physic (see page 206, [symbol] [symbol] [symbol] [symbol] [symbol] Γ.C. 1967Γ. [4]), the power required for motion is:

N_{req.}=F_{gen.}V,

wherein: F_{gen.} is a general motion drag,
V is a motion speed.

F_{gen.}=F_{fr.}+X_{aer.}

wherein: F_{fr.}=mk=490(N) is a drag upon of resistance to rolling friction,
X_{aer.} is an aerodynamic drag to a motion (see page 49, [symbol] [symbol] [symbol] JI.X., [symbol] [symbol] 1982. [5]).

X_{aer.}=X_{aut.}+X_{pp.}

wherein: X_{aut.} is an aerodynamic drag of the automobile without of the power plant CAPP:

X_{aut.}=C_{x aut.}S_{aut.}(ρV²/2)=94(N),

wherein: C_{x aut.}=0.3 is a coefficient of the automobile parasitic drag (it is analogously with respect to an a bluff shaped aircraft fuselage),
S_{aut.}=2M² is an area of the automobile cross section (a maximum mid-section),
ρ=1,225 κΓ/M³ is an air density.
X_{pp.} is an aerodynamic drag of aerodynamic portion (of the air unit) of the power plant CAPP:

### X_{pp.}=C_{x pp.}S_{a.u.}(ρV²/2)=91(N),

wherein: C_{x pp.}=1.16 is a coefficient of parasitic drag of the aerodynamic portion (the air unit) of the power plant CAPP (it is analogously with respect to a flat plate, which is placed crosswise a flow),
S_{a.u.}=0.5M² is an area of cross section of the air unit (an area of cross section of a louver),
ρ=1.225 κΓ/M³ is a density of air.

Correspondingly the power required for the uniform rectilinear traffic of the automobile with the power plant CAPP, is :

N_{req.}=F_{gen.}V=(F_{fr.}+X_{aut.}+X_{pp.})V==(490+94+91)16=10800(W)=11 KW.

Thus, upon the value of the required N_{req.}=11 kW, that is necessary for the car 1 uniform rectilinear motion, the power plant CAPP with a general area of inlet section in the air unit, which equals to 0.5 m², is capable to generate 7 kW and it makes up approximately of 65% of the power required for the uniform rectilinear motion, i.e.,:

N_{el.}=0.65N_{req.}

Upon the power plant CAPP exploitation in transport means of rail type (a locomotive, electric train and so on) its effectiveness may reach amount to more high significances:

N_{el.}=0.95N_{req.}

by means of significant constriction of the coefficient of resistance to rolling friction (from fivefold to tenfold) and the presence of long rectilinear horizontal sections of railway bed.

Under a provision of all the electrical aggregates of railway transport means with an electric energy in a sufficient quantity the electrical energy additionally generated by the power plant CAPP from the incoming air flow may be transferred in main electrical mains via contact booms analogously to the transferring of recuperative electrical energy generated by means of known way upon a braking of railway transport. In such a manner via the contact booms it is possible the electrical energy transferring generated by means of the power plant in the electrical mains in its exploitation in town electric transport (a tram, trolleybus, metro and so on).

The exploitation of the declared power plant CAPP in combination with the known power aggregates allows to constrict significantly a consumption of various kinds of fuel and energy by transport means by the help of effective conversion of the kinetic energy of the incoming air flow into the electrical energy for a provision of transport means traffic. For example, an operation of the power plant CAPP with petrol, diesel an other engines, using a hydrocarbon raw material or any bio-fuel, allows to constrict its consumption not less than twofold.

Upon the operation of the power plant CAPP in combination with hybrid power plants analogous to the power plants of Toyota Prius, Ford Escape, Lexus RX 400h and so on the fuel consumption by these cars may be decreased already threefold—fourfold with respect to their basic models, but not one and a half to twofold as it has a place upon their present exploitation.

The exploitation of the power plant CAPP in combination with electrical motors of various types in electro-mobiles allows to increase an action radius of the electro-mobile along a straight way with an average cruiser speed of traffic (of 50 to 70 km/h) not less than threefold to fourfold.

Upon the exploitation of the power plant CAPP in railway transport and in town electrical transport (electrical trains of long distance, electrical trains of metropolitan and so on) by means of conversion of kinetic energy of incoming air flow into electric energy it is possible a significant energy releasing and its redistribution to other consumers of electrical mains.

### INDUSTRIAL APPLICABILITY

The usage of the declared plant CAPP allows to obtain novel vehicle types, ecologically pure ones and capable to change on principle the existing transport system. A cost of price of transported cargo tonne-kilometre by automobile transport decreases approximately twofold, but by railway transport threefold to fourfold, and it allows to decrease transportation expenses and tariffs for a transported production. A generation of electrical energy for transport means with the declared power plant, using the renewable source of energy (the incoming air flow), allows significantly to decrease a dependence first of all from hydrocarbon grades of fuel.

But the main advantage upon the exploitation of the transport means with the declared power plant CAPP is attained with respect to ecologic parameters by means of decrease of CO, CO₂ and hazardous emissions as well as by means of decrease of thermal influence on atmosphere, and it is more than favorable for decrease of glasshouse effect and for improvement of ecology as a whole.

1. A vehicle power plant comprising an engine connected to a vehicle propelling device and an aerodynamic construction including at least one wind wheel with blades, carried out with a possibility of energy obtaining from an incoming air flow and generating an electrical energy by means of an electric generator connected to it in order to transfer the electrical energy to the vehicle propelling device, wherein in a vicinity of the wind wheel being mounted guiding vanes, providing an optimal angle of flow-around of that wind wheel by the incoming air flow, and straightening vanes after the wind wheel blades, therewith the straightening vanes of one wind wheel are guiding vanes of other wind wheel, following after it.

2. The vehicle power plant as set forth in claim 1 wherein the guiding vanes are carried out with a possibility of their pivoting motion with respect to their longitudinal axes.

3. The vehicle power plant as set forth in claim 2 wherein the guiding vanes and the wind wheel blades in their cross-section have a convex and concave gas-dynamic cambered aerofoil.

4. The vehicle power plant as set forth in claim 2 wherein the guiding vanes and the wind wheel blades are carried out with an aerodynamic and geometric twist.

5. The vehicle power plant as set forth in claim 1 wherein the incoming air flow enters into an aerodynamic construction via an air intake of controlled cross-section.

6. The vehicle power plant as set forth in claim 5 wherein the controlled cross-section of the aerodynamic construction is capable of its size decreasing till zero.

7. The vehicle power plant as set forth in claim 5 and 6 wherein the controlled cross-section of the aerodynamic construction is capable of its parasitic drag decreasing till zero.

8. The vehicle power plant as set forth in claim 1 wherein the wind wheels are positioned in the vicinity with respect to one another with a minimal gap between own constructive elements in axial and radial directions.

9. The vehicle power plant as set forth in claim 1 wherein the electrical generator is connected to at least one electrical accumulating battery connected to the vehicle propelling device drive.
